(19) United States
(12) Patent Application Publication
(10) Pub. No.: US 2009/0299732 A1
(43) Pub. Date: Dec. 3, 2009

(54) CONTEXTUAL DICTIONARY INTERPRETATION FOR TRANSLATION

(75) Inventors: Wang HAO, Beijing (CN); Tang YUEZHONG, Beijing (CN)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 12/129,059

(22) Filed: May 29, 2008

(51) Int. Cl. G06F 17/21

(52) U.S. Cl. 704/10

(57) ABSTRACT

A method and apparatus provides for interpreting a foreign word or phrase using a contextual likelihood model and a dictionary. An apparatus may translate foreign language text by taking context into account and displaying the translation with alternatives on an adaptive user interface display. The contextual likelihood model may be interlaced with a dictionary. In an embodiment, the interaction between the contextual likelihood model and a dictionary may result in an adaptive adjustment of the meanings or the order of meanings displayed. The order of meanings displayed may be representative of the calculated likelihoods.

### FIELD OF INVENTION

The invention relates generally to a method and apparatus for facilitating context based translation of different languages.

### BACKGROUND

Globalization is driving people actively or passively to use multiple languages in their daily lives. Thus, language translation has become an important task in many instances. For example, many people that are attempting to learn a second language often encounter new words when they read newspapers or magazines written in a foreign language. Without proper translation of the new words, the meaning of the newspaper or magazine may not be fully understood. Also, tourists or business travelers visiting foreign countries may not understand signs or markers as they may not be knowledgeable in a particular foreign language. A translation solution would allow tourists and/or business travelers to more fully enjoy their travels.

Therefore, for the foregoing reasons, a method and apparatus for an improved language translation model for use in mobile devices would be advantageous.

### SUMMARY

Many of the aforementioned problems are solved by providing a method and apparatus for interpreting a word or phrase using a contextual likelihood model. One embodiment relates to a method comprising steps of receiving a signal having an environmental cue; parsing the environmental cue into word segments; receiving a selection of a parsed word segment for translation; determining at least one dictionary meaning of selected word segment; determining a likelihood of the at least one dictionary meaning; ranking the at least one dictionary meaning based on the determined likelihood; and displaying the ranked at least one dictionary meaning. An apparatus and computer-readable medium comprising executable instructions suitable for carrying out the method are also included.

In an aspect of the invention, a contextual likelihood model may be interlaced with a dictionary. In an embodiment, the interaction between the contextual likelihood model and a dictionary may result in an adaptive adjustment of the meanings or the order of meanings displayed. The order of meanings displayed may be representative of the calculated likelihoods.

In another aspect of the invention, the contextual likelihood model provides a scalable system in which an on-line contextual likelihood model may be used with mobile devices. In an embodiment, off-line training may be conducted through use of a language model, the output of which may be used to update the on-line contextual likelihood model.

These as well as other advantages and aspects of the invention are apparent and understood from the following detailed description of the invention, the attached claims, and the accompanying drawings.

### BRIEF DESCRIPTION OF THE DRAWINGS

The present invention is illustrated by way of example and not limited in the accompanying figures in which like reference numerals indicate similar elements.

FIG. 1 illustrates a block diagram of a communication system in accordance with an aspect of the invention.

FIG. 2 illustrates an apparatus in accordance with an aspect of the invention.

FIG. 3 illustrates a flow diagram for a contextual likelihood model in accordance with an aspect of the invention.

FIG. 4 illustrates exemplary user interface displays for a method of context translation in accordance with an aspect of the invention.

FIG. 5 illustrates a method of contextual likelihood translation in accordance with an aspect of the invention.

FIG. 6 illustrates a method of filtering and/or pre-pressing in accordance with an aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

In an aspect of the invention, optical character recognition (OCR) may be used to enable text input, recognition, and translation of text into another language. For example, optical character recognition may be applied to pictures taken with cameras or other devices, the pictures containing foreign language text. The use of optical character recognition may enable users to input text without having to be familiar with foreign language characters and/or sentence structure. In an embodiment, a dynamic user interface screen may display a ranked list of possible meanings of translated text.

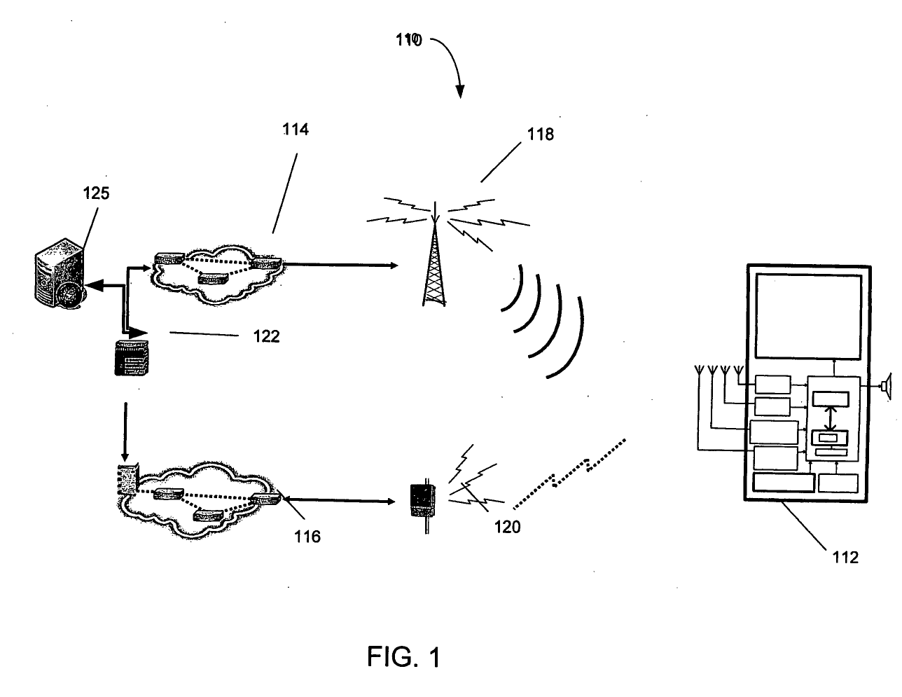

Aspects of the present invention may be utilized across a broad array of networks and communication protocols. FIG. 1 illustrates an example of a wireless communication system 110 in which systems and methods according to at least some embodiments may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 (which may include the Internet or similar network) and/or a cellular network 116. The mobile terminal/device 112 may include a digital broadband broadcast receiver device. The service source 122 may be connected to several service providers such as advertisement source 125 that may provide their actual program content or information or description of their services and programs to the service source 122 that further provides the content or information to the mobile device 112. The several service providers including advertisement source 125 may include but are not limited to one or more television and/or digital television service providers, AM/FM radio service providers, advertisement servers and/or providers, SMS/MMS push service providers, Internet content or access providers.

In one or more arrangements, broadcast network 114 may broadcast data from one or more service sources such as service source 122. Service source 122 may obtain or receive data from a server or provider 125. The data may then be received by mobile terminal 112 through the broadcast network 114 and stored in a database for display to a user of terminal 112. One method of broadcasting data is using IP datacasting (IPDC). IPDC combines digital broadcasting and Internet Protocol. As such, a variety of information and services may be transmitted using such a network and protocol.

The mobile device 112 may also send and receive messages to and from the service source 122 through the cellular network 116. The cellular network 116 may include a wireless network and a base transceiver station transmitter 120. The cellular network may include a second/third-generation (2G/3G) cellular data communications network, a Global System for Mobile communications network (GSM), a Universal Mobile Telecommunications System (UMTS) and/or other wireless communication network such as a WLAN network. In one or more aspects, communications through the cellular network 116 may allow a service source 122 to distribute on an individual basis. That is, rather than broadcasting data to an entire subscriber population, the service source 122 may obtain and distribute data based on user interests, usage statistics, a user's most frequent time of use and the like. Alternatively or additionally, mobile device 112 may access either the broadcast network 114 or cellular network 116 to retrieve information from a server or content provider 122.

In accordance with one aspect of the invention, mobile device 112 may include a wireless interface configured to send and/or receive digital wireless communications within cellular network 116 using base transceiver station transmitter 120. The information received by mobile device 112 through the cellular network 116 or broadcast network 114 via a cellular network tower 118 may include user input or selection (for example, in an interactive transmission), applications, services, electronic images, content requests, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

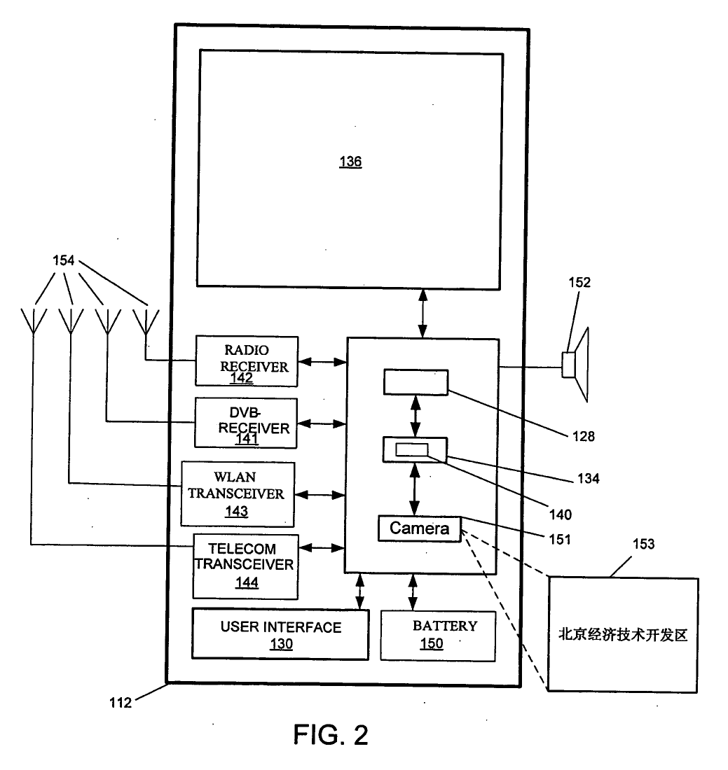

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, four arrow keys, joy-stick, stylus, data glove, mouse, roller ball, touch screen, or the like. In addition, user interface 130 may include the entirety of or portion of display 136. Mobile device 112 may also include a camera 151 to capture image data.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of the computer executable instructions may be embodied in hardware or firmware (not shown).

Mobile device 112 may be configured to receive, decode and process digital broadband broadcast transmissions through various receivers such as DVB receiver 141, FM/AM Radio receiver 142, WLAN transceiver 143, and telecommunications transceiver 144. In one aspect of the invention, mobile device 112 may receive radio data stream (RDS) messages.

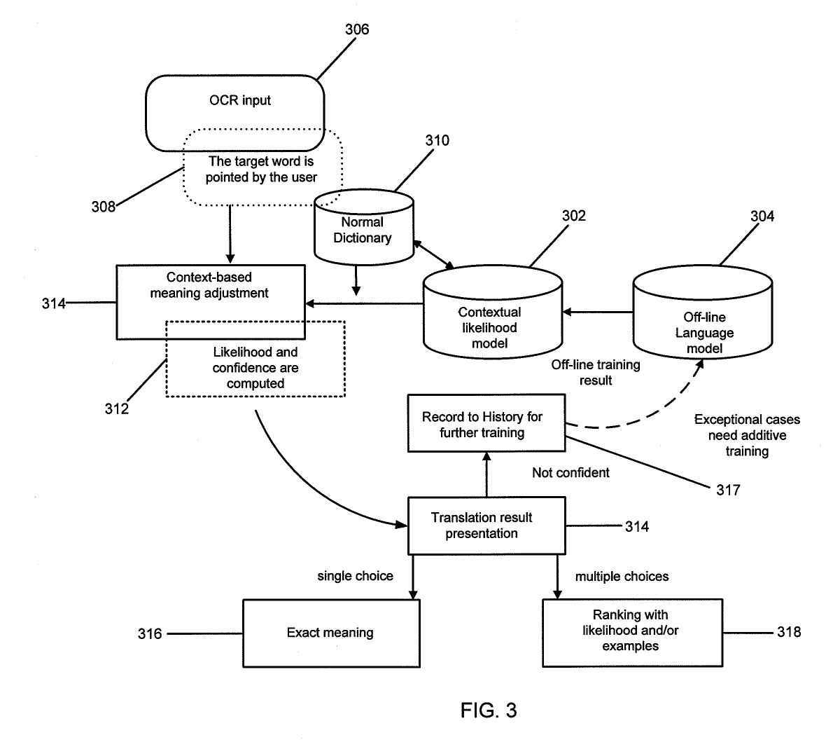

FIG. 3 illustrates a flow diagram in accordance with an aspect of the invention. In FIG. 3, a contextual likelihood model 302 may be based on a more powerful off-line language model 304. In an embodiment, the contextual likelihood model may used in mobile or portable devices. Such mobile or portable devices may have limited processing or storing capacity. The contextual likelihood model 302 may be utilized on-line for adjusting a static order listing of determined dictionary meanings for a selected word or phrase. The contextual likelihood model 302 may provide a scalable apparatus for language translation. In an embodiment, the contextual likelihood model 302 may be capable of determining an exact meaning of a word or phrase based on context-based computing. In another embodiment, if the contextual likelihood model 302 does not provide a valid output, the context may be taken as additive training material to be used by the off-line language model 304. Such training material may be used by the off-line language model 304 to update the on-line contextual likelihood model 302.

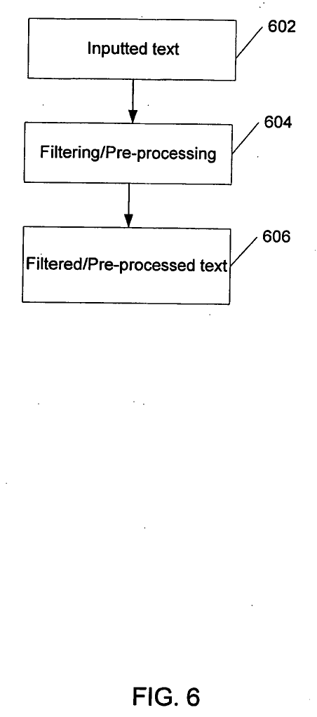

In an aspect of the invention, contextual likelihood model 302 may consider translation on a semi-sentence level or phrase segment level rather than on a paragraph or a full sentence level. In an embodiment, contextual likelihood model 302 may use categories of context from which a suitable meaning of a target word or phrase segment may be determined. The contextual likelihood model 302 may also include pre-processing and/or filtering steps to improve computational run time. For instance, FIG. 6 illustrates that input text 602 may be filtered and/or pre-processed, at step 604, in accordance with an aspect of the invention. The results of the filtering/pre-processing, filtered/pre-processed text 606, may be used as input text for translation.

In an embodiment, different languages may involve different pre-processing steps. For instance, in the Chinese language there exists some auxiliary words such as [symbol] and function word like [symbol] , etc., which are not of use in translation and may not be interpreted. In an embodiment, these words may be filtered out and then the likelihood value may be determined. For example, [symbol] may be a phrase or word segment needing translation. In an embodiment, the word segment may be parsed as [symbol] In this embodiment, [symbol] may be an auxiliary word, which can be removed. In an aspect of the invention, the likelihood model may only consider the relationship of the main words, such as [symbol] (watch), [symbol] (game).

In FIG. 3, an input such as an optical character recognition input 306 may be received in accordance with an aspect of the invention. The OCR input 306 may be based on information received from camera 151 (FIG. 2). Camera 151 may capture images of foreign text contained on a sign 153 (FIG. 2) or any written material for translation purposes. This corresponds generally to a step of receiving a signal containing an environmental cue. For example, a user may select a sign written in a foreign language that needs to be translated to determine proper meaning in the user's native language. In an aspect of the invention, the user may directly enter the words or phrases to be translated through use of an input device such as keyboard. In another aspect of the invention, a user may take a picture of the words or phrases to be translated and through OCR the foreign words and phrases may be processed for translation in a mobile device.

In an aspect of the invention, a user may select a particular portion of a phrase or a target word for translation as illustrated in step 308. In an embodiment, a dictionary 310 may be used to determine the meaning of the selected phrase or target word. A contextual likelihood model 302 may determine a likelihood and confidence 312 for each of the determined meanings of the selected phrase or target word in order to provide a context based adjustment to the determined meaning as illustrated at step 314. The calculated likelihoods and confidences for each of the determined meaning may be used to rank each of the determined meanings. The ranked translations of the selected phrase or target word may be displayed to the user. In an embodiment, if only one meaning has been determined then that meaning may be presented to the user as shown in step 316. In another embodiment, if more than one meaning is determined for the phrase or target word then a ranked list of those meanings may be displayed to the user as illustrated in step 318. In yet another embodiment, the ranked translations may be displayed along with examples of the usage corresponding to the context. This may further assist the user in determining if a proper translation has been determined and displayed.

In another aspect of the invention, the contextual likelihood model provides a scalable system in which an on-line contextual likelihood model may be used with mobile devices. In an embodiment, as shown in step 317 if a confidence or likelihood value can not be determined for the translation then the information may be used for off-line training that may be conducted through use of a language model 304, the output of which may be used to update the on-line contextual likelihood model 302. In an embodiment, the contextual likelihood model 302 may be updated while on-line.

In another aspect of the invention, training in the context of source language may also be performed. Such training may be useful to determine the meaning of the word (to be translated) in source language. For example, to translate word B in the context A+B+C, it may be helpful to calculate the context of B in the source language at first to determine the meaning of B in the context—i.e., D (in the source language). This may provide a translation of B in the target language like T1, T2, or T3, and translation of D like T4, T1, or T5. This may make it more efficient to identify that T1 is likely to be the exact meaning of B in context in the target language.

In yet another aspect of the invention, training may occur in both the source and target languages. For instance it may be useful to consider the categories at first as the number of categories is normally much smaller than the number of meanings. For example, word A may have translations in the target language M1, M2, M3, M4, and M5 (five meanings). However, these five meanings may be classified into two categories (C1, C2). A category may refer to syntactical functions and morphological features, or some other features. [symbol] may be used as an example. The example includes three words: A, B, and C. A may be [symbol] (economy), C may be [symbol] (development). Both A and B may be nouns (noun category). According to linguistic rules or statistic model, it may be concluded that B may also be a noun rather than an adjective (adjective category). In addition, [symbol] may have multiple translations. In an embodiment, one translation may be “technology” (noun), and another may be “technical” (adjective). In an embodiment, “technology” may therefore be ranked before “technical”.

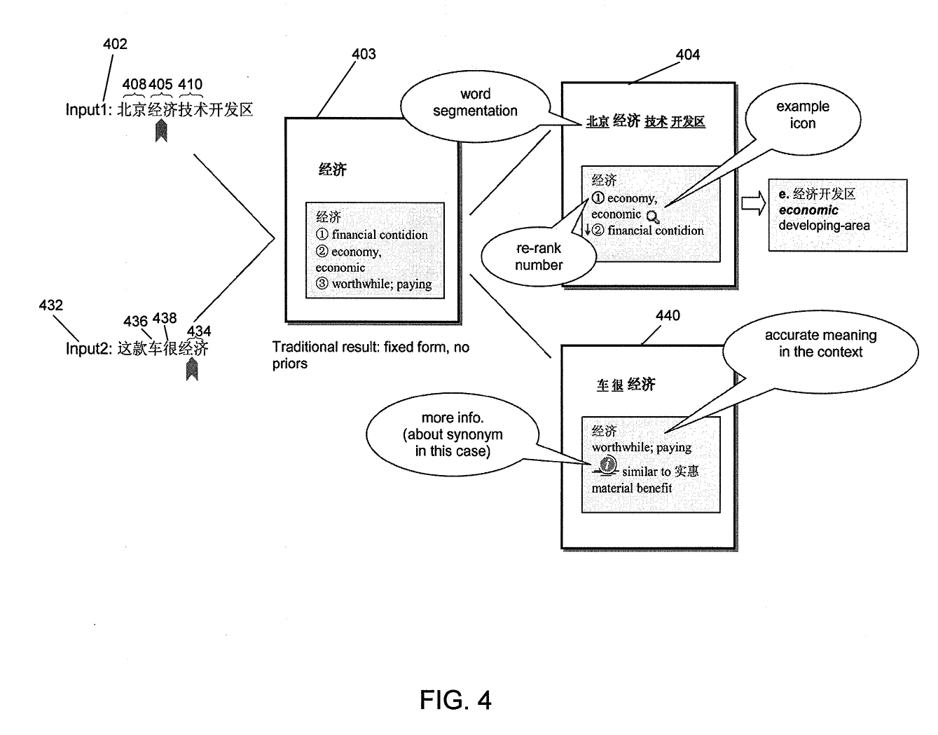

FIG. 4 illustrates exemplary user interface displays for a method of context translation in accordance with an aspect of the invention. In FIG. 4, an input1 [symbol] [symbol] 402 is received for translation. In an embodiment, input1 402 may be parsed into phrase segments using a dictionary and a forward/backward matching algorithm. The possible meanings of the phrase segments may be determined. The contextual likelihood model 302 may compute the likelihood of each determined meaning. For instance, there may be three different meanings for input1 402 whose confidences are higher than a predefined threshold. These meanings may be displayed to a user on a display screen such as display screen 403 and then subsequently reordered based on their determined contextual likelihoods as shown on display screen 404. For instance, [symbol] 405 which is part of input1 402 may be selected by a user for contextual translation. In an embodiment, [symbol] 405 may have three potential meanings as displayed to a user on user interface screen 403. The three potential translation options for [symbol] 405 may include: 1) financial, 2) economy, and 3) worthwhile. In an aspect of the invention, words or phrases which are adjacent to [symbol] 405 may be searched and translated. For example, [symbol] 408 and [symbol] 410 may be discovered and their dictionary meaning determined. For instance, [symbol] 408 may be translated to mean “Beijing” and [symbol] 410 may be determined to mean “technology.”

In an aspect of the invention, a three-gram contextual likelihood model may be utilized. The three-gram contextual likelihood model may compute the likelihoods of “Beijing financial”, “Beijing financial technology”, and “financial technology” separately as L1, L2, and L3, respectively. Next, the final likelihood of “financial” may be determined based on the computed likelihoods L1, L2, and L3. For example, in an embodiment, the final likelihood of “financial” may be determined by the equation:

L=w1*L1+w2*L2+w3L3

Where w1, w2, w3 are weights which may be based on a training corpus.

Similarly, in an embodiment of the invention, the final likelihoods of “economy” and “worthwhile” may also be determined using the above equation. The determined final likelihoods of the three translation options may be ranked in decreasing order as shown in display screen 404.

In another aspect of the invention, other translation options may also be utilized. For example, in translation [symbol] 410 other options for translation may be presented along with the technology meaning. Such translation options may include technical and technique.

Furthermore, as illustrated in display screen 404 in some embodiments there may be additional options for the same item. For example, the translation of [symbol] 405 may include two possible meanings such as economy and economic. In an embodiment, these two possible meanings may also be used while computing likelihoods.

In another aspect of the invention, a second input2 [symbol] 432 may be illustrative of various aspects of the invention. In FIG. 4, [symbol] 434 which is part of input2 432 may be selected by a user for contextual translation. In an embodiment, [symbol] 434 may have three potential meanings as displayed to a user on display screen 403. The three potential translation options for [symbol] 434 may include: 1) financial, 2) economy, and 3) worthwhile. In an aspect of the invention, words or phrases which are adjacent to [symbol] 432 may be searched and translated. For example, [symbol] 436 and [symbol] 438 may be discovered and their dictionary meaning determined. For instance, [symbol] 436 may be translated to mean “car” and [symbol] 438 may be determined to mean “very,” respectively. The contextual likelihood model 302 may compute the likelihood of financial by computing “car very financial” and “very financial.” Similarly, the contextual likelihood model 302 may also determine the likelihoods of “economy” and “worthwhile.” In an embodiment, the final likelihood of these options may be ranked in decreasing order as shown in display screen 440.

In another aspect of the invention, a threshold level may be determined to remove options with a determined low likelihood or confidence. As those skilled in the art will realize, the threshold level may be altered and/or adjusted. In an embodiment, confidence may be calculated as a function of likelihood, together with other information such as rules and templates. For instance, in the above input2 432 exemplary embodiment, the “worthwhile” definition may be the only definition whose calculated likelihood can pass an established threshold and is therefore selected as the accurate meaning in the context as shown in display screen 440.

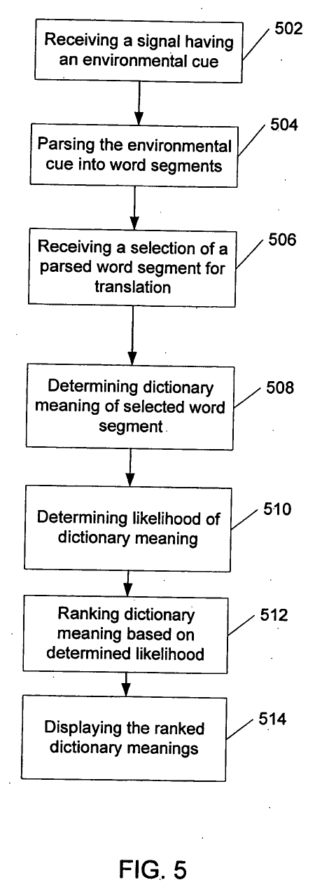

FIG. 5 illustrates a method for interpreting a word or phrase using a contextual likelihood model. In FIG. 5, at step 502 a signal having an environmental cue may be received. Next, in step 504 the environmental cue may be parsed into word segments. In step 506, a selection of a parsed word segment may be received for translation. Next, in step 508 at least one dictionary meaning may be determined. In step 510, a likelihood of the at least one dictionary meaning may be calculated. Next, in step 512 a ranking of the at least one dictionary meaning based on the determined likelihood may be generated. Finally, in step 514 the generated ranking may be displayed for the determined dictionary meanings.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A method comprising:
receiving a signal having an environmental cue;
parsing the environmental cue into phrase segments;
receiving a selection of a parsed phrase segment for translation;
determining at least one dictionary meaning of selected phrase segment;
determining a contextual likelihood of the at least one dictionary meaning;
ranking the at least one dictionary meaning based on the determined contextual likelihood; and
displaying the ranked at least one dictionary meaning.

2. The method of claim 1, wherein the displayed ranked at least one dictionary meaning further comprises displaying an example of usage for the dictionary meaning.

3. The method of claim 1, further comprising displaying the parsed phrase segments.

4. The method of claim 1, wherein the determining of the contextual likelihood of the at least one dictionary is determined on-line.

5. The method of claim 1, further comprising filtering phrase segments.

6. The method of claim 1, wherein if a likelihood is not determined based on the at least one dictionary meaning, using the at least one dictionary meaning to train an off-line language model.

7. The method of claim 6, wherein the off-line language model provides updates to an on-line contextual likelihood model.

8. The method of claim 1, wherein the environment cues include visual cues taken with a camera.

9. The method of claim 8, wherein the visual cues include pictures having at least one text portion for translation.

10. An apparatus, comprising:
a processor; and
memory storing computer-readable instructions that cause the processor to perform:
receiving a signal having an environmental cue;
parsing the environmental cue into phrase segments;
receiving a selection of a parsed phrase segment for translation;
determining at least one dictionary meaning of selected phrase segment;
determining a contextual likelihood of the at least one dictionary meaning;
ranking the at least one dictionary meaning based on the determined contextual likelihood; and
displaying the ranked at least one dictionary meaning.

11. The apparatus of claim 10, wherein the displayed ranked at least one dictionary meaning further comprises displaying an example of usage for the dictionary meaning.

12. The apparatus of claim 10, further comprising displaying the parsed phrase segments.

13. The apparatus of claim 10, wherein the determining of the contextual likelihood of the at least one dictionary is determined on-line.

14. The apparatus of claim 10, further comprising filtering phrase segments.

15. The apparatus of claim 10, wherein if a likelihood is not determined based on the at least one dictionary meaning, using the at least one dictionary meaning to train an off-line language model.

16. The apparatus of claim 10, wherein the off-line language model provides updates to an on-line contextual likelihood model.

17. The apparatus of claim 10, wherein the environment cues include visual cues taken with a camera.

18. The apparatus of claim 17, wherein the visual cues include pictures having at least one text portion for translation.

19. A computer-readable storage medium encoded with instructions that, when executed by a computer, perform:
receiving a signal having an environmental cue;
parsing the environmental cue into phrase segments;
receiving a selection of a parsed phrase segment for translation;
determining at least one dictionary meaning of selected phrase segment;
determining a contextual likelihood of the at least one dictionary meaning;
ranking the at least one dictionary meaning based on the determined contextual likelihood; and
displaying the ranked at least one dictionary meaning.

20. The computer-readable media of claim 19, wherein the displayed ranked at least one dictionary meaning further comprises displaying an example of usage for the dictionary meaning.

21. The computer-readable media of claim 20, further comprising displaying the parsed phrase segments.

22. The computer-readable media of claim 20, wherein the determining of the contextual likelihood of the at least one dictionary is determined on-line.

23. The computer-readable media of claim 20, further comprising filtering phrase segments.

24. The computer-readable media of claim 20, wherein if a likelihood is not determined based on the at least one dictionary meaning, using the at least one dictionary meaning to train an off-line language model.

25. The computer-readable media of claim 20, wherein the off-line language model providing updates to an on-line contextual likelihood model.

26. The computer-readable media of claim 20, wherein the environment cues include visual cues taken with a camera.

27. The computer-readable media of claim 26, wherein the visual cues include pictures having at least one text portion for translation.

28. A method comprising:
receiving a signal having an environmental cue;
parsing the environmental cue into phrase segments;
filtering the phrase segments;
displaying the filtered phrase segments;
receiving a selection of a parsed phrase segment for translation;
determining at least one dictionary meaning of selected phrase segment;
determining a contextual likelihood of the at least one dictionary meaning;
ranking the at least one dictionary meaning based on the determined contextual likelihood; and
displaying the ranked at least one dictionary meaning.

29. The method of claim 28, wherein the determining of the contextual likelihood of the at least one dictionary is determined on-line.

30. The method of claim 28, wherein if a likelihood is not determined based on the at least one dictionary meaning, using the at least one dictionary meaning to train an off-line language model.

31. The method of claim 30, wherein the off-line language model provides updates to an on-line contextual likelihood model.

32. An apparatus, comprising:
a processor; and
memory storing computer-readable instructions that cause the processor to perform:
receiving a signal having an environmental cue;
parsing the environmental cue into phrase segments;
filtering the phrase segments;
displaying the filtered phrase segments;
receiving a selection of a parsed phrase segment for translation;
determining at least one dictionary meaning of selected phrase segment;
determining a contextual likelihood of the at least one dictionary meaning;
ranking the at least one dictionary meaning based on the determined contextual likelihood; and
displaying the ranked at least one dictionary meaning.

33. The apparatus of claim 32, wherein the displayed ranked at least one dictionary meaning further comprises displaying an example of usage for the dictionary meaning.

34. An apparatus comprising:
a processor;
memory;
means for determining at least one dictionary meaning of selected phrase segment and a contextual likelihood of the at least one dictionary meaning;
means for ranking the at least one dictionary meaning based on the determined contextual likelihood; and
means for displaying the ranked at least one dictionary meaning.

35. The apparatus of claim 34, wherein the means for displaying the ranked at least one dictionary meaning further comprises means for displaying an example of usage for the dictionary meaning.
